(19) United States
(12) Patent Application Publication
(10) Pub. No.: US 2013/0181545 A1
(43) Pub. Date: Jul. 18, 2013

(54) DRIVE DEVICE CAPABLE OF GENERATING A DRIVING OUTPUT BASED ON A MAGNETIC FIELD

(71) Applicant: DAH-PRONG LAI, TAIPEI COUNTY (TW)

(72) Inventor: DAH-PRONG LAI, TAIPEI COUNTY (TW)

(21) Appl. No.: 13/746,623

(22) Filed: Jan. 22, 2013

Related U.S. Application Data
(63) Continuation-in-part of application No. 12/823,229, filed on Jun. 25, 2010, now abandoned.

(30) Foreign Application Priority Data
Jun. 29, 2009 (TW) 098121844

(51) Int. Cl. H02K 3/02

(52) U.S. Cl. CPC H02K 3/02
USPC 310/12.04

(57) ABSTRACT

A drive device capable of generating a driving output based on a magnetic field includes multiple magnetic and conductive strips adjacently but electrically isolatively positioned on a face. One of the magnetic and conductive strips has a current input end, while another has a current output end. The magnetic and conductive strips are magnetizable in the same direction to form a magneto-conductive section. Multiple bridging conductor members are bridged between opposite ends of the adjacent magnetic and conductive strips to together form a coil structure. When current flows with the angle contained between the direction of the current flowing through the magnetic and conductive strips and the magnetization direction not zero, the magnetic lines are conducted and concentrated on the magneto-conductive section to achieve a net Lorentz force for pushing the drive device.

### CROSS-REFERENCE TO RELATED APPLICATION

This application is a continuation-in-part application of U.S. patent application Ser. No. 12/823,229, entitled “motor capable of generating a driving output based on a magnetic field”, filed on Jun. 25, 2010, currently pending.

### BACKGROUND OF THE INVENTION

1. Field of the Invention

The present invention relates generally to a drive device capable of generating a driving output based on a magnetic field, and more particularly to a drive device, which is applicable in a magnetic field to achieve a net Lorentz force as a thrust force for the drive device.

2. Description of the Related Art

A conventional motor includes a rotor having a permanent magnet, a stator, and a stator coil wound on the stator. The rotor rotates in response a magnetic field induced by a current flowing through the stator coil such that the conventional motor generates a rotary output for rotationally driving an object, such as a propeller or a wheel. The external fluid or the ground will apply a reaction force to the propeller or the wheel to drive an airplane, a boat or a vehicle forward.

Once the reaction force disappears, the motor will idle. For example, when a vehicle sinks into quicksand, the vehicle will be unable to move forward. Also, it is impossible for a propeller airplane to fly in the outer space without air.

The recently developed maglev train works on the principle of linear motor. By means of controlling the magnetic field, the driving force for the maglev train can be changed.

At the present time, the thrust force for correcting the revolution orbit or speeding the satellite in the space is achieved by means of burning fuel to eject gas out of the satellite. When the fuel carried by the satellite is about to be exhausted, the thin air in the outer space will apply a resistance against revolution of the satellite around the earth. Therefore, the satellite will gradually slowdown and finally drop onto the earth due to too slow revolution speed. In the case that it is undesired to drop the satellite onto the earth, the remaining fuel can be used to push the satellite to a more remote place to become a space trash. Under such circumstance, the lifetime of the expensive satellite is terminated due to exhaustion of fuel. This is quite uneconomic. It is therefore tried by the applicant to provide a drive device capable of generating a driving output based on a magnetic field. The drive device of the present invention is applicable to a satellite in the magnetic field of the earth to provide the necessary thrust force for the satellite instead of the fuel. Therefore, the lifetime of the satellite can be prolonged and the satellite can be further used without waste.

### SUMMARY OF THE INVENTION

It is therefore a primary object of the present invention to provide a drive device capable of generating a driving output based on a magnetic field. The drive device of the present invention is applicable to a satellite in the magnetic field of the earth to provide the necessary thrust force for the satellite instead of the fuel. Therefore, the problem existing in the conventional technique that the satellite will stop revolving due to exhaustion of fuel is solved.

To achieve the above and other objects, the drive device capable of generating a driving output based on a magnetic field of the present invention includes multiple magnetic and conductive strips and multiple bridging conductor members in adaptation to the magnetic and conductive strips. The magnetic and conductive strips are side by side adjacently but electrically isolatively positioned on a magneto-conductive face. One of the magnetic and conductive strips has a current input end for input of current, while another of the magnetic and conductive strips has a current output end for output of current. The magnetic and conductive strips are magnetizable in the same direction to form a magneto-conductive section. The bridging conductor members are bridged between opposite ends of the adjacent magnetic and conductive strips, whereby the magnetic and conductive strips and the bridging conductor members together form a coil structure. When current flows into the current input end and flows out from the current output end with the angle contained between the direction of the current flowing through the magnetic and conductive strips and the magnetization direction not zero, the magnetic lines are conducted and concentrated on the magneto-conductive section. In this case, the Lorentz force applied by the magnetic field to the magneto-conductive section is greater than the Lorentz force applied to the bridging conductor members to achieve a net Lorentz force for pushing the drive device.

The above drive device further includes a first magnetic plate and a second magnetic plate respectively positioned on two sides of the magnetic and conductive strips. The normal lines of the first and second magnetic plates are substantially perpendicular to the extension direction of the magnetic and conductive strips. The first and second magnetic plates are made from a soft magnetic material and magnetizable by the magnetic field.

In the above drive device, the first and second magnetic plates preferably perpendicularly intersect the magneto-conductive face.

In the above drive device, insulation members are disposed between the adjacent magnetic and conductive strips to provide magneto-conductive but electrical insulation effect.

The above drive device further includes at least one magneto-conductive tube. The bridging conductor members are contact-freely fitted in the magneto-conductive tubes to enhance the magnetic inductivity of the magnetic and conductive strips to the magnetic field.

The above drive device further includes a reverse coil. The reverse coil and the bridging conductor members are respectively positioned on two sides of the magnetic and conductive strips. When current is input to the reverse coil to flow through one side of the reverse coil, which side is proximal to the magnetic and conductive strips, in a direction reverse to the direction of the current flowing through the magnetic and conductive strips, the magnetic vortexes generated by the reverse coil can offset the magnetic vortexes generated by the bridging conductor members to enhance the magnetic inductivity of the magnetic and conductive strips to the magnetic field.

According to the drive device of the present invention, the magnetic flow can be conducted to go from the first magnetic plate through the magnetic and conductive strips to the second magnetic plate in a path with smaller magnetic resistance. In this case, when the drive device is positioned in a uniform magnetic field, the magnetic field domain centered at the magnetic and conductive strips will have a flux density greater than that of the magnetic field domain where the bridging conductor members are position. In this case, when current flows through the coil structure of the present invention, a net Lorentz force between the magnetic and conductive strips and the bridging conductor members in a specific direction is achieved. In a magnetic field such as the magnetic field around of the earth, the net Lorentz force serves as a thrust force for the drive device.

The present invention can be best understood through the following description and accompanying drawings, wherein:

### BRIEF DESCRIPTION OF THE DRAWINGS

FIG. 1 is a perspective assembled view of a first embodiment of the present invention;

FIG. 2 is a perspective exploded view of the first embodiment of the present invention;

FIG. 3 is a front view of the first embodiment of the present invention;

FIG. 4 is a top view of the first embodiment of the present invention;

FIG. 5 is a view showing that an external magnetic field acts on the first embodiment of the present invention;

FIG. 6 is a view showing the flux density according to FIG. 5;

FIG. 7 is a sectional view of a second embodiment of the present invention;

FIG. 8 is a perspective view of a third embodiment of the present invention;

FIG. 9 is a schematic diagram showing that the drive device of the present invention is installed in a satellite; and

FIG. 10 is a schematic diagram showing that the drive device of the present invention is positioned in the magnetic field of the earth.

### DETAILED DESCRIPTION OF THE PREFERRED EMBODIMENTS

Before the present invention is described in greater detail, it should be noted that like elements are denoted by the same reference numerals throughout the disclosure.

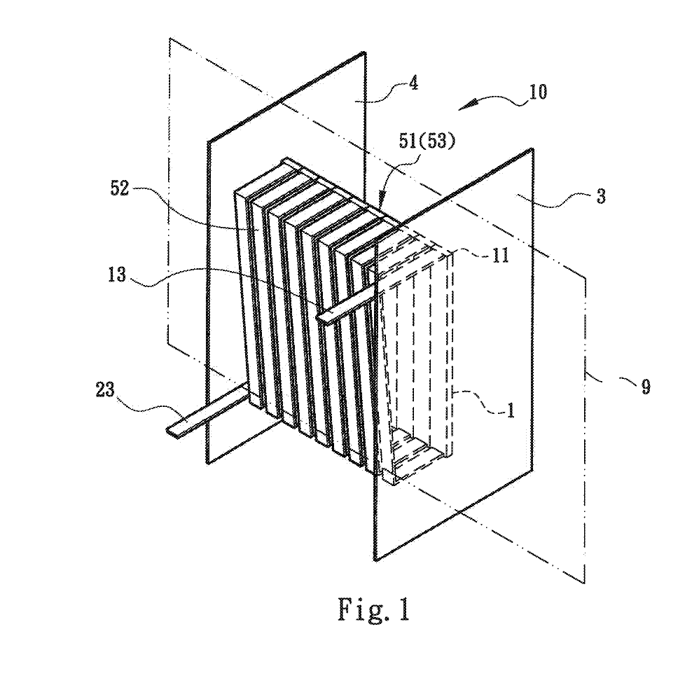

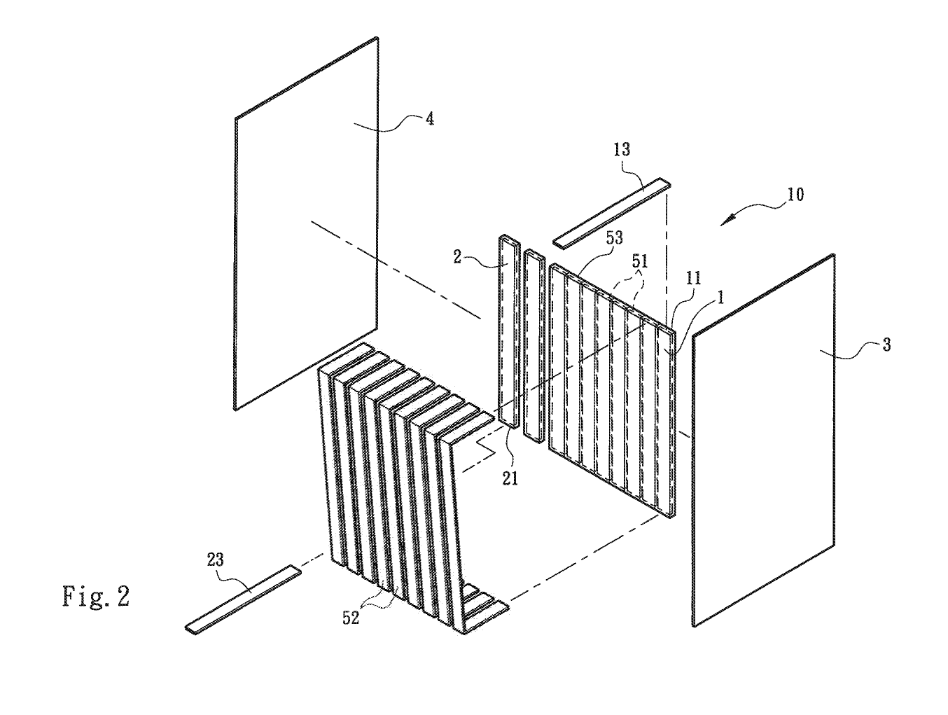

Please refer to FIGS. 1 and 2. FIG. 1 is a perspective assembled view of a first embodiment of the drive device 10 capable of generating a driving output based on a magnetic field of the present invention. FIG. 2 is a perspective exploded view of the first embodiment of the drive device 10 of the present invention. According to the first embodiment, the drive device 10 is applicable in a uniform magnetic field 8 to generate a driving output. For example, the drive device 10 can be positioned in the magnetic field around the earth to achieve a driving output of Lorentz force. The drive device 10 includes multiple magnetic and conductive strips 51 side by side adjacently positioned on a magneto-conductive face 9 and at least one bridging conductor member 52 in adaptation to the magnetic and conductive strips 51. The bridging conductor member 52 is bridged between two opposite ends of each two adjacent magnetic and conductive strips 51, whereby the bridging conductor members 52 and the magnetic and conductive strips 51 together form a coil structure. Two most lateral magnetic and conductive strips 51 of the magnetic and conductive strips 51 are respectively defined as a first magnetic and conductive strip 1 and a second magnetic and conductive strip 2. The first and second magnetic and conductive strips 1, 2 are further respectively connected to a first magnetic plate 3 and a second magnetic plate 4. The first and second magnetic plates 3, 4 intersect the magneto-conductive face 9, and preferably perpendicularly intersect the magneto-conductive face 9. The drive device 10 further includes a first conductive section 13 connected with a current input end 11 of the first magnetic and conductive strip 1 and a second conductive section 23 connected with a current output end 21 of the second magnetic and conductive strip 2. The first and second conductive sections 13, 23 are adapted to permit input and output of current.

It should be noted that in this embodiment, the magnetic and conductive strips 51 are all made from a soft magnetic and conductive material. The magnetic and conductive strips 51 are side by side adjacently arranged and can be magnetized by the magnetic field in the same direction to form a magneto-conductive section on the magneto-conductive face 9. However, the magnetic and conductive strips 51 are electrically isolated from each other. The first and second magnetic plates 3, 4 are made from a soft magnetic material and can be magnetized by the magnetic field in the same direction. In this embodiment, the magnetic and conductive strips 51 are made from, but not limited to, permalloy of J50 lever. Alternatively, the magnetic and conductive strips 51 can be made from any other material with good magnetism and electro-conductivity.

In this embodiment, the drive device 10 includes ten magnetic and conductive strips 51 and nine bridging conductor members 52. The conductive strips 51 are side by side sequentially arranged on the magneto-conductive face 9. The extension direction of the magnetic and conductive strips 51 is approximately perpendicular to the normal line of the first and second magnetic plates 3, 4. The numbers of the magnetic and conductive strips 51 and the bridging conductor members 52 are not limited to the above numbers. In practice, the numbers of the magnetic and conductive strips 51 and the bridging conductor members 52 can be adjusted according to actual requirements. It should be noted that insulation members 53 are disposed between the adjacent magnetic and conductive strips 51 of the drive device 10 to provide insulation effect. Accordingly, the current flowing into the first magnetic and conductive strip 1 from the first conductive section 13 will not directly pass through the magnetic and conductive strips 51 and flow to the current output end 21 of the second magnetic and conductive strip 2. Instead, the current will sequentially flow through the bridging conductor members 52 and the magnetic and conductive strips 51 and finally flow to the second magnetic and conductive strip 2 and flow out from the second conductive section 23 in a coiled form. This is equivalent to a coil. In this embodiment, the insulation members 53 are, but not limited to, insulation paint or other enclosure-type insulation material enclosing the magnetic and conductive strips 51. Only the parts of the magnetic and conductive strips 51 that are connected with the first and second conductive sections 13, 23 and the bridging conductor members 52 are exposed.

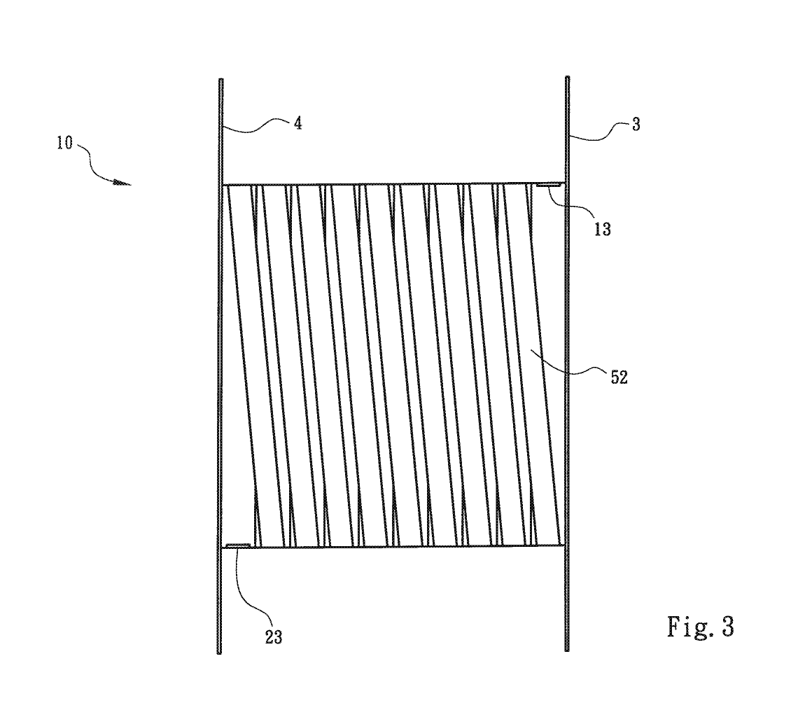

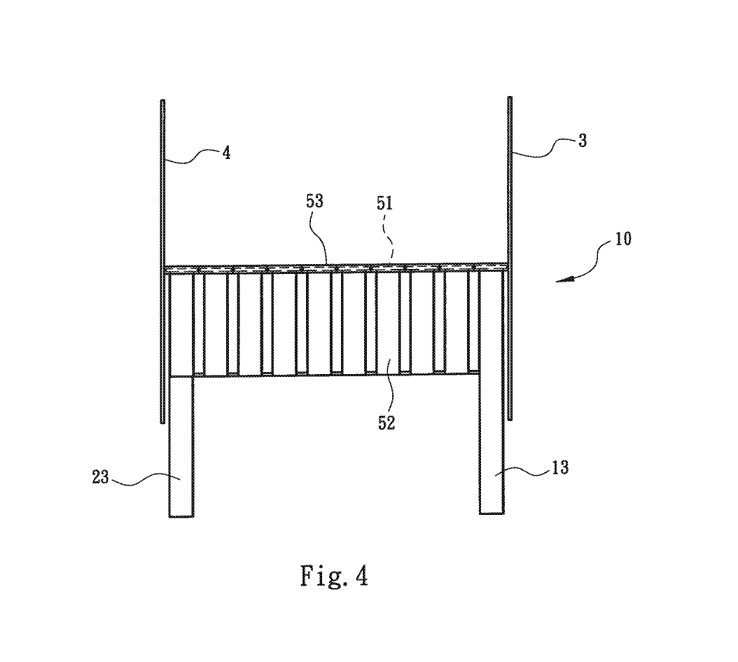

Please now refer to FIGS. 3 and 4. FIG. 3 is a front view of the first embodiment of the present invention. FIG. 4 is a top view of the first embodiment of the present invention.

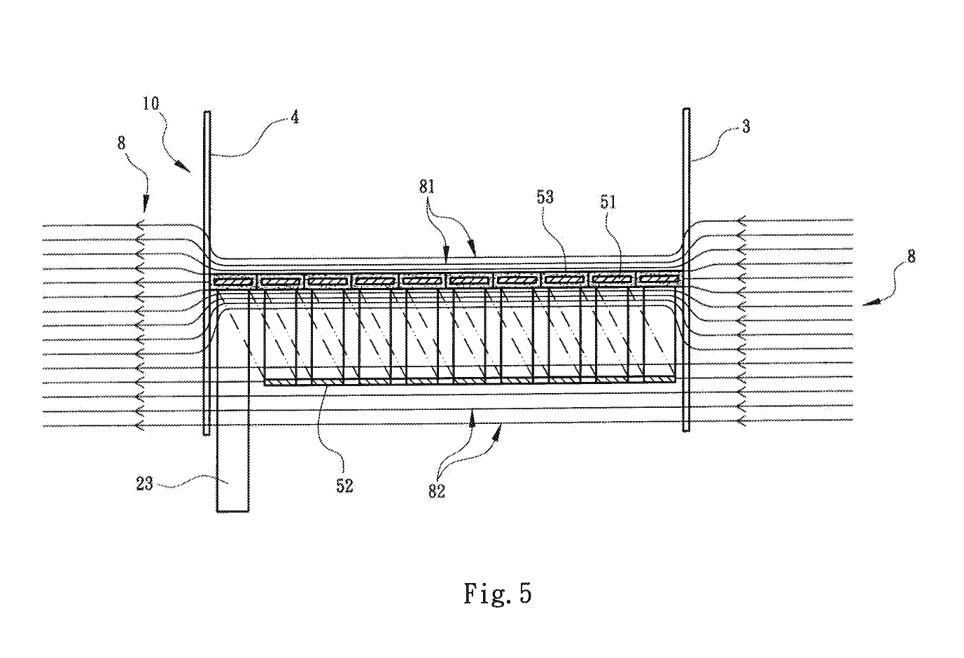

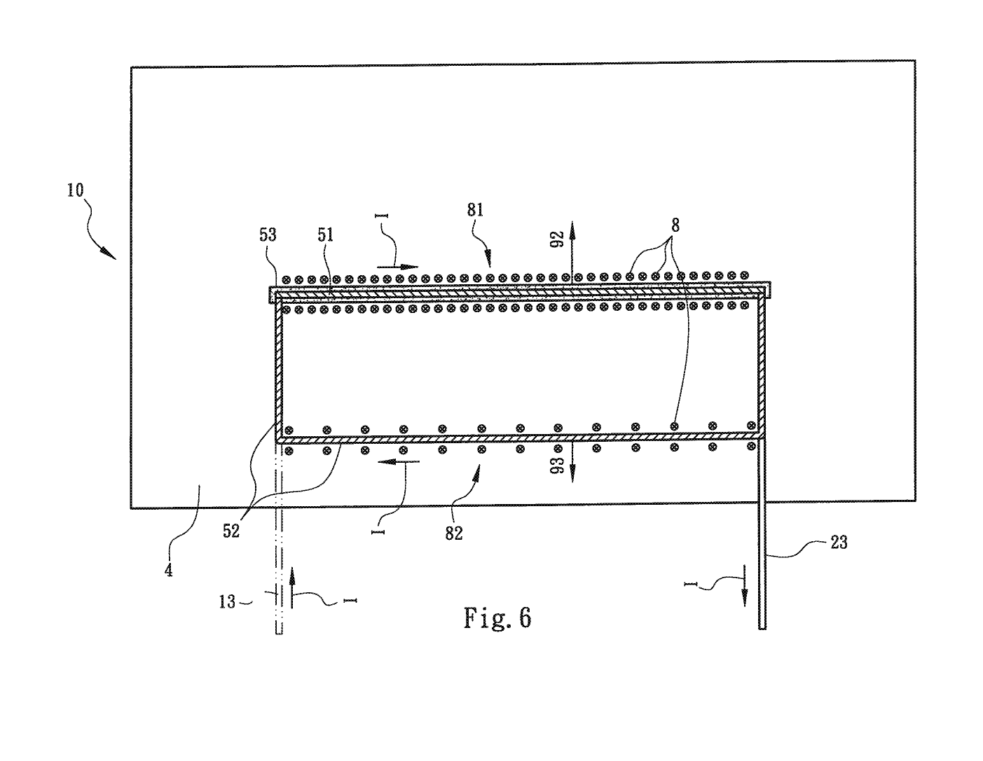

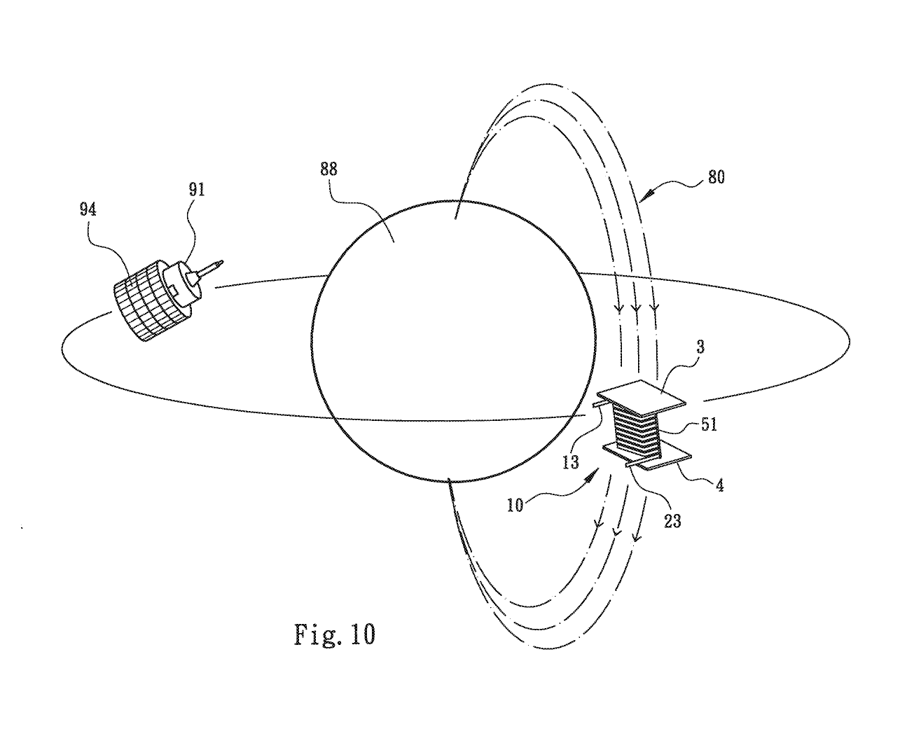

Also referring to FIG. 1, when the drive device 10 is positioned in a magnetic field 8 (such as the magnetic field 80 of the earth as shown in FIG. 10) generated by a magnetic field source (not shown), the magnetic and conductive strips 51 and the first and second magnetic plates 3, 4 will be magnetized in the same direction (referring to FIG. 5). In this case, the flux density of the magnetic field domain 81 centered at the magneto-conductive face 9 formed of the magnetic and conductive strips 51 is greater than the flux density of the magnetic field domain 82 where the bridging conductor members 52 are position (also referring to FIGS. 5 and 6). That is, due to magnetic conductivity, the flux density of the magnetic field domain 81 centered at the magneto-conductive face 9 is much greater than the flux density of the magnetic field domain 82 where the bridging conductor members 52 are position. Therefore, when the current flows from the first conductive section 13 to the second conductive section 23, the magnetic field 8 will interact with the current to respectively apply Lorentz force 92 onto the magnetic and conductive strips 51 and Lorentz force 93 onto the bridging conductor members 52. The Lorentz force 92 will be much greater than the Lorentz force 93. The net Lorentz force, that is, the driving output, is directed in the direction of Lorentz force 92.

Through simulative calculation of computer, experimental results of the Lorentz force 92, the Lorentz force 93 and the net Lorentz force with respect to different currents input to the first conductive section 13 are achieved as shown in Tables 1 to 3 respectively, wherein Table 1 shows the Lorentz force applied to the magnetic and conductive strips 51 in a set magnetic field domain with respect to different input currents, Table 2 shows the Lorentz force applied to the bridging conductor members 52 in the same conditions and Table 3 shows the net Lorentz force of the Lorentz force applied to the magnetic and conductive strips 51 and the Lorentz force applied to the bridging conductor members 52. In the tables, in the case that the Lorentz force is positive, the Lorentz force is directed in the direction of arrow 92, while in the case that the Lorentz force is negative, the Lorentz force is directed in a direction reverse to the direction of arrow 92.

TABLE 1

| current (A/m²) | Lorentz force (N) |
|---|---|
| 1 | 5.27E−05 |
| 10 | 5.25E−04 |
| 100 | 5.10E−03 |

TABLE 2

| current (A/m²) | Lorentz force (N) |
|---|---|
| 1 | −6.08E−08 |
| 10 | −5.83E−07 |
| 100 | −6.11E−06 |

TABLE 3

| current (A/m²) | Lorentz force (gw) |
|---|---|
| 1 | 5.38E−03 |
| 10 | 5.36E−02 |
| 100 | 5.21E−01 |

It should be noted that the current can be alternatively input to the second conductive section 23 and output from the first conductive section 13. In this case, the net Lorentz force applied to the drive device 10 is directed in the direction of arrow 93. The direction of the net Lorentz force applied to the drive device 10 is not limited to the direction of arrow 92 or 93. In practice, the direction of the net Lorentz force applied to the drive device 10 can be changed according to actual requirements.

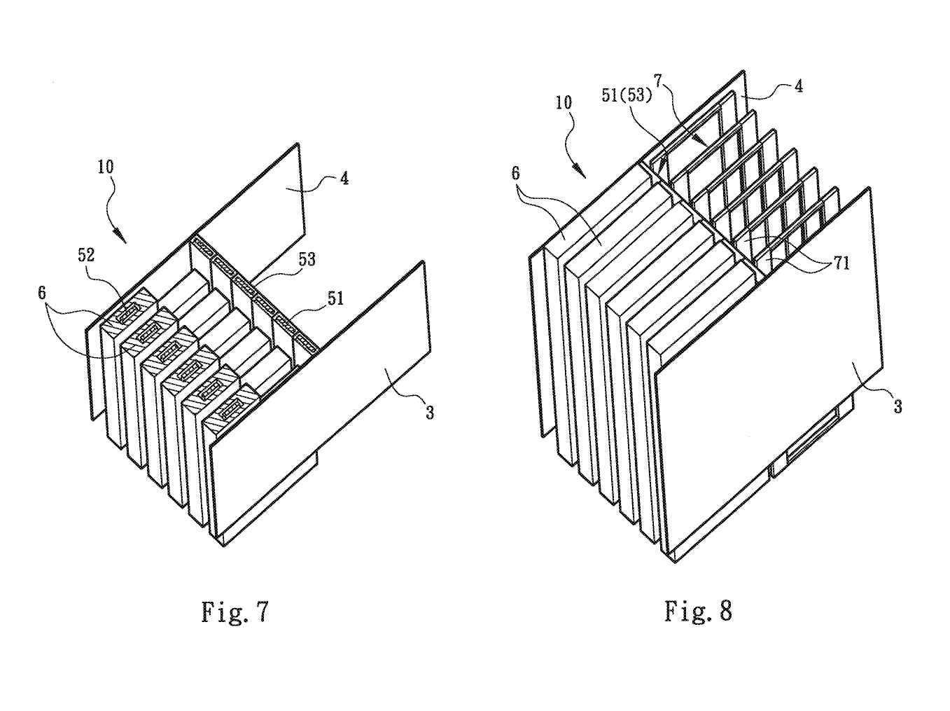

Please now refer to FIG. 7, which is a sectional view of a second embodiment of the present invention. The magnetic flux containable by the soft magnetic material is limited due to (magnetic saturation). Therefore, when too intensive current is input, the magnetic vortexes generated by the bridging conductor members 52 will massively penetrate through the magnetic and conductive strips 51. This will deteriorate the magnetic inductivity of the magnetic and conductive strips 51 to the magnetic field 8. In this case, it is impossible to achieve an effective Lorentz force. Therefore, in the second embodiment, the drive device 10 further includes multiple magneto-conductive tubes 6 made of soft magnetic material. The bridging conductor members 52 are contact-freely fitted in the magneto-conductive tubes 6. Accordingly, most of the magnetic vortexes generated by the bridging conductor members 52 are confined within the magneto-conductive tubes 6. This can greatly lower the ill affection to the magnetic inductivity of the magnetic and conductive strips 51 to the magnetic field 80 of the earth.

Please now refer to FIG. 8, which is a perspective view of a third embodiment of the present invention. Also for reducing the ill affection of the magnetic vortexes generated by the bridging conductor members 52 to the magnetic inductivity of the magnetic and conductive strips 51, the third embodiment further includes a reverse coil 7. The reverse coil 7 and the bridging conductor members 52 are respectively positioned on two sides of the magnetic and conductive strips 51. Current is input to the reverse coil 7 to flow through one side 71 of the reverse coil 7, which side is proximal to the magnetic and conductive strips 51, in a direction reverse to the direction of the current flowing through the magnetic and conductive strips 51. In this case, the affection of the magnetic vortexes generated by the reverse coil 7 to the magnetic and conductive strips 51 can just offset the affection of the magnetic vortexes generated by the bridging conductor members 52 to the magnetic and conductive strips 51. This can also enhance the magnetic inductivity of the magnetic and conductive strips 51 to the magnetic field 8.

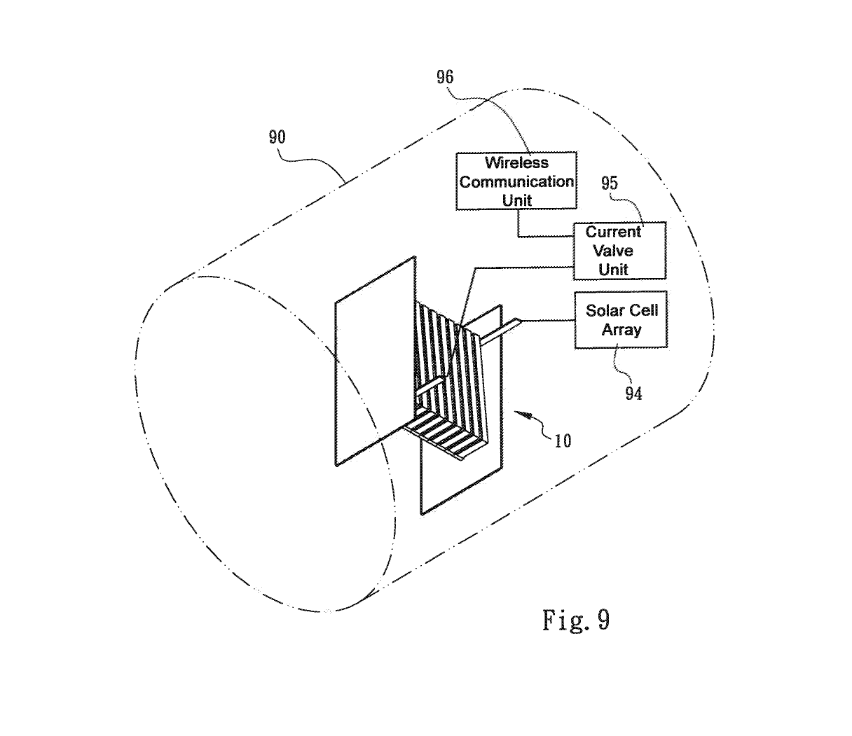

It should be noted that the drive device 10 of the present invention is applicable to a satellite to correct the revolution orbit of the satellite or provide the thrust necessary for speeding the satellite. Please refer to FIG. 9, which is a schematic diagram showing that the drive device 10 of the present invention is installed in a satellite 90. Also referring to FIG. 10, the satellite 90 with the drive device 10 is positioned in the magnetic field 80 around the earth 88. A solar battery array 94, which is generally provided for a satellite 91, is used to store power. In addition, a current valve unit 95 is used to actively control the current input to the drive device 10 from the solar battery array 94. Alternatively, a wireless communication unit 96 can be used to receive an external instruction to make the current valve unit 95 control the current input to the drive device 10. Accordingly, different intensities of current can be input in different directions to interact with the magnetic field 80 around the earth so as to apply different magnitudes of Lorentz force to the drive device 10 in different directions. Therefore, the direction and magnitude of the Lorentz force can be controlled to correct the revolution orbit of the satellite or provide the thrust necessary for speeding the satellite. The earth 88 has its own magnetic field in the surrounding space and the solar battery array 94 has been long since widely employed in the satellite as a natural energy. Therefore, the drive device 10 of the present invention can be applied to a satellite to provide the necessary thrust force instead of the fuel. In this case, the problem existing in the conventional technique that the satellite will stop revolving due to exhaustion of fuel can be solved.

In conclusion, according to the drive device 10 of the present invention, the magnetic flow can be conducted to go from the first magnetic plate 3 through the magnetic and conductive strips 51 to the second magnetic plate 4 in a path with smaller magnetic resistance. In this case, when the drive device 10 is positioned in an external magnetic field 8, the magnetic field domain 81 centered at the magneto-conductive face 9 formed of the magnetic and conductive strips 51 will have a greater flux density and a higher magnetic field intensity. In this case, when current flows into the drive device 10 from the first conductive section 13 or the second conductive section 23, a net Lorentz force between the magnetic and conductive strips 51 and the bridging conductor members 52 in a specific direction. In a given external magnetic field 8 (such as the magnetic field 80 of the earth), the net Lorentz force serves as a thrust force for the drive device 10. In the second embodiment, the bridging conductor members 52 are enclosed in the magneto-conductive tubes 6 to lower the ill affection to the magnetic inductivity of the magnetic and conductive strips 51 to the magnetic field 80 of the earth. In the third embodiment, the magnetic vortexes generated by the reverse coil 7 can offset the magnetic vortexes generated by the bridging conductor members. This can also enhance the magnetic inductivity of the magnetic and conductive strips 51 to the magnetic field 80 of the earth.

The above embodiments are only used to illustrate the present invention, not intended to limit the scope thereof. Many modifications of the above embodiments can be made without departing from the spirit of the present invention.

What is claimed is:

1. A drive device capable of generating a driving output based on a magnetic field, the drive device comprising multiple magnetic and conductive strips side by side adjacently positioned on a magneto-conductive face, the magnetic and conductive strips being electrically isolated from each other, the magnetic and conductive strips having a current input end for input of current and a current output end for output of current, all the magnetic and conductive strips being made from a magnetic and conductive material, the drive device further comprising at least one bridging conductor member bridged between two opposite ends of two adjacent magnetic and conductive strips, whereby the magnetic and conductive strips and the bridging conductor member together form a coil structure and current can flow into the current input end and flow out from the current output end, the magnetic and conductive strips being magnetizable by the magnetic field in the same direction to form a magneto-conductive section on the magneto-conductive face for achieving a net Lorentz force between the magneto-conductive section and the bridging conductor members.

2. The drive device capable of generating a driving output based on a magnetic field as claimed in claim 1, further comprising a first magnetic plate and a second magnetic plate respectively positioned on two sides of the magnetic and conductive strips, the first and second magnetic plates intersecting the magneto-conductive face, the first and second magnetic plates being made from a soft magnetic material and being magnetizable by the magnetic field.

3. The drive device capable of generating a driving output based on a magnetic field as claimed in claim 2, wherein the first and second magnetic plates perpendicularly intersect the magneto-conductive face.

4. The drive device capable of generating a driving output based on a magnetic field as claimed in claim 1, wherein insulation members are disposed between the magnetic and conductive strips to provide insulation effect.

5. The drive device capable of generating a driving output based on a magnetic field as claimed in claim 2, wherein insulation members are disposed between the magnetic and conductive strips to provide insulation effect.

6. The drive device capable of generating a driving output based on a magnetic field as claimed in claim 3, wherein insulation members are disposed between the magnetic and conductive strips to provide insulation effect.

7. The drive device capable of generating a driving output based on a magnetic field as claimed in claim 4, wherein the magnetic and conductive strips are enclosed in the insulation members.

8. The drive device capable of generating a driving output based on a magnetic field as claimed in claim 7, wherein each insulation member is formed of at least one layer of insulation material.

9. The drive device capable of generating a driving output based on a magnetic field as claimed in claim 1, further comprising at least one magneto-conductive tube, the bridging conductor members being contact-freely fitted in the magneto-conductive tubes.

10. The drive device capable of generating a driving output based on a magnetic field as claimed in claim 2, further comprising at least one magneto-conductive tube, the bridging conductor members being contact-freely fitted in the magneto-conductive tubes.

11. The drive device capable of generating a driving output based on a magnetic field as claimed in claim 3, further comprising at least one magneto-conductive tube, the bridging conductor members being contact-freely fitted in the magneto-conductive tubes.

12. The drive device capable of generating a driving output based on a magnetic field as claimed in claim 4, further comprising at least one magneto-conductive tube, the bridging conductor members being contact-freely fitted in the magneto-conductive tubes.

13. The drive device capable of generating a driving output based on a magnetic field as claimed in claim 5, further comprising at least one magneto-conductive tube, the bridging conductor members being contact-freely fitted in the magneto-conductive tubes.

14. The drive device capable of generating a driving output based on a magnetic field as claimed in claim 6, further comprising at least one magneto-conductive tube, the bridging conductor members being contact-freely fitted in the magneto-conductive tubes.

15. The drive device capable of generating a driving output based on a magnetic field as claimed in claim 1, further comprising a reverse coil, the reverse coil and the bridging conductor members being respectively positioned on two sides of the magnetic and conductive strips, current being input to the reverse coil to flow through one side of the reverse coil, which side is proximal to the magnetic and conductive strips, in a direction reverse to the direction of the current flowing through the magnetic and conductive strips.

16. The drive device capable of generating a driving output based on a magnetic field as claimed in claim 2, further comprising a reverse coil, the reverse coil and the bridging conductor members being respectively positioned on two sides of the magnetic and conductive strips, current being input to the reverse coil to flow through one side of the reverse coil, which side is proximal to the magnetic and conductive strips, in a direction reverse to the direction of the current flowing through the magnetic and conductive strips.

17. The drive device capable of generating a driving output based on a magnetic field as claimed in claim 3, further comprising a reverse coil, the reverse coil and the bridging conductor members being respectively positioned on two sides of the magnetic and conductive strips, current being input to the reverse coil to flow through one side of the reverse coil, which side is proximal to the magnetic and conductive strips, in a direction reverse to the direction of the current flowing through the magnetic and conductive strips.

18. The drive device capable of generating a driving output based on a magnetic field as claimed in claim 4, further comprising a reverse coil, the reverse coil and the bridging conductor members being respectively positioned on two sides of the magnetic and conductive strips, current being input to the reverse coil to flow through one side of the reverse coil, which side is proximal to the magnetic and conductive strips, in a direction reverse to the direction of the current flowing through the magnetic and conductive strips.

19. The drive device capable of generating a driving output based on a magnetic field as claimed in claim 9, further comprising a reverse coil, the reverse coil and the bridging conductor members being respectively positioned on two sides of the magnetic and conductive strips, current being input to the reverse coil to flow through one side of the reverse coil, which side is proximal to the magnetic and conductive strips, in a direction reverse to the direction of the current flowing through the magnetic and conductive strips.
